(19) United States
(12) Patent Application Publication
(10) Pub. No.: US 2023/0166907 A1
(43) Pub. Date: Jun. 1, 2023

(54) SYSTEM FOR HANDLING AND INSTALLING FORKLIFT FORKS AND OTHER ATTACHMENTS

(71) Applicant: Arrow Acquisition, LLC, Lenexa, KS (US)

(72) Inventor: Scott A. Clevenger, Pleasant Hill, MO (US)

(21) Appl. No.: 18/073,548

(22) Filed: Dec. 1, 2022

Related U.S. Application Data
(60) Provisional application No. 63/284,947, filed on Dec. 1, 2021.

(51) Int. Cl. B65G 1/02

(52) U.S. Cl. CPC B65G 1/02; B66F 9/06

(57) ABSTRACT

A system for handling and installing forklift forks is provided. The system may include two fork pockets, which may be elongated rectangular tubes. The fork pockets may be substantially parallel to one another and connected by one or more crossmembers. At a proximal end, the fork pockets may include tube openings for receiving forks coupled to a forklift. In addition to the tube openings, a hook and a chain may couple the system for handling and installing forklift forks to the forklift. At a distal end, the system for handling and installing forklift forks may include means for handling forks. In one embodiment, an opening is configured to receive and retain blades of forks. In another embodiment, a front plate is configured to engage a hook portion of forks. In yet another embodiment, a shaft mounting apparatus is provided to engage with shaft-mounted forks.

### CROSS-REFERENCE TO RELATED APPLICATIONS

Application claims priority to U.S. Provisional Pat. Application Serial No. 63/284,947, filed on Dec. 1, 2021, to Scott A. Clevenger, entitled “System for Handling and Installing Forklift Forks,” currently pending, the entire disclosure of which is incorporated herein by reference.

### BACKGROUND OF INVENTION

There is a myriad of types of industrial and construction equipment designed for lifting, handling, and moving materials. Such equipment includes forklifts, telehandlers, skid steers, hilo vehicles, walkie-rider pallet jacks, and wheel loaders, among a variety of others. These pieces of equipment can be used in a variety of settings for lifting and moving a wide range of items. Such items include heavy items stored on pallets, various raw materials, and various manufactured goods. These pieces of equipment typically require attachments (e.g., forks, buckets, spears, grapples, and the like). The attachments are typically designed for lifting and moving specific materials and objects.

In the case of a forklift, the attachment is generally a fork attachment that is coupled to a carriage on the forklift. The carriage on the forklift may be vertically movable to lift and maneuver the fork attachment. The fork attachments are typically elongated tines that are used as a pair. In some cases, the elongated tines are designed to lift a pallet. However, fork attachments may also be designed for other specific uses. For example, “block forks” are designed specifically to handle bricks, and “fully tapered and polished forks” are configured to efficiently handle stacked materials.

Due to the respective advantages of the various types of attachments, an equipment operator may wish to change the attachment on a piece of equipment, such as a forklift, when switching between materials or tasks. In addition, the operator may wish to move the unused attachments to a storage location when the spare attachments are not in use. Accordingly, operators may frequently handle, move, and install attachments on forklifts and other pieces of equipment. Furthermore, attachments such as forks are moved, stored, and transported by manufacturers, wholesalers, dealers, owners, and operators.

Conventional methods for handling, moving, and installing attachments on a piece of equipment are not without deficiencies. For example, the most common method is to handle, move, and install the attachments manually or by hand. This manual process requires one or more human laborers to physically interact with the attachments when the attachments are moved from one location to another, mounted on a piece of equipment, or unmounted from a piece of equipment. Because the attachments are relatively large and heavy, manually moving the attachments requires considerable time and effort. Due to the difficulty and duration, the cost of the labor to handle, move, and install attachments can be high. In addition, this manual process can pose safety concerns. For example, while handling heavy attachments, the laborer may be at risk for a lifting-related injury. In addition, while installing or uninstalling the attachments, the laborer may stand in front of the equipment and place their hands near mechanical components. As a result, the laborer may be at an increased risk for a machine-related injury while installing or uninstalling the attachments. Therefore, a need exists for a system for handling and installing attachments and a method of using the same. Preferably, the system and method may have increased efficiency, decreased cost, and improved safety when compared to conventional methods for moving, handling, and installing attachments.

### BRIEF SUMMARY OF THE INVENTION

The present invention is directed generally to a system for handling and installing attachments. Through various means, the system for handling and installing attachments may be configured to be selectively coupled to a first forklift and to spare or loose forklift forks. As a result, the system for handling and installing attachments may be referred to as a system for handling and installing forklift forks.

According to one embodiment of the present invention, the system for handling and installing forklift forks may include first and second longitudinally extending fork pocket members, a first crossmember extending between and coupled to the first fork pocket member and the second fork pocket member, and a second crossmember positioned below and vertically spaced apart from the first crossmember. The first and second fork pocket members may be elongated tubes that are generally parallel with one another. A fork opening can be defined at least partially between the first crossmember and the second crossmember, wherein the fork opening is configured to receive a blade portion of one or more forklift forks. In one embodiment, the system further includes a first side vertical member coupled to and depending downwardly from the first fork pocket member, a second side vertical member coupled to and depending downwardly from the second fork pocket member, wherein the second crossmember extends between and is coupled to lower ends of both the first side vertical member and the second side vertical member. In this embodiment, the front fork opening is defined by the first crossmember, the second crossmember, the first side vertical member, and the second side vertical member. To assist in engaging and receiving the forklift forks within the fork opening, the second crossmember (i.e., the lower crossmember) includes at least one beveled edge. It will be appreciated that the first and second fork pocket members can each define a pocket opening proximate the second end of the system, wherein the pocket openings are configured to receive forks attached to a forklift, and wherein the fork opening is proximate a first end of the system. In one embodiment, a third crossmember extends between and is coupled to the first fork pocket member and the second fork pocket member. In such a system, when the forklift forks are received in and extend through the fork opening, bottom sides of the blade portions of the forklift forks rest on the second crossmember and a top side of the blade portions contact the third crossmember.

In another embodiment, the system includes a front upwardly extending projection proximate the first end of the system and extending between the first fork pocket member and the second fork pocket member. The front upwardly extending projection can be configured for being received within a hook portion of forklift forks, such as clip-mount forks or ITA forks. In one embodiment, the front upwardly extending projection is a plate, which has a thickness configured for being received within the hook portion of the forklift forks.

In yet a further embodiment, the system includes a shaft mounting apparatus proximate the first end of the system, wherein the shaft mounting apparatus includes a horizontally extending portion configured for being received within collars of shaft-mounted forklift forks. The horizontally extending portion may extend generally perpendicular to the longitudinally extending fork pocket members. The shaft mounting apparatus can include a generally vertically extending portion, wherein the horizontally extending portion is coupled to the vertically extending portion. The vertically extending portion can be angled forwardly such that the horizontally extending portion is a forwardmost element of the system.

Other aspects and advantages of the present invention will be apparent from the following detailed description of the preferred embodiments and the accompanying drawing figures.

### BRIEF DESCRIPTION OF THE SEVERAL VIEWS OF THE DRAWING

In the accompanying drawings, which form a part of the specification and are to be read in conjunction therewith, like reference numerals are used to indicate like or similar parts in the various views:

FIG. 1 is a perspective view of a forklift as known in the art;

FIG. 2A is a perspective view of a pair of ITA forks as known in the art;

FIG. 2B is a perspective view of a pair of shaft-mounted forks as known in the art;

FIG. 3 is a top view of a system for handling and installing forklift forks in accordance with one embodiment of the present invention;

FIG. 4 is a bottom perspective view of the system for handling and installing forklift forks of FIG. 3;

FIG. 5 is a top perspective view of the system for handling and installing forklift forks of FIG. 3;

FIG. 6 is a top perspective view of a system for handling and installing forklift forks in accordance with another embodiment of the present invention;

FIG. 7 is a side elevation view of the system for handling and installing forklift forks of FIG. 6;

FIG. 8A illustrates a first step for using the system for handling and installing forklift forks of FIG. 3 in accordance with a first method of practicing the present invention;

FIG. 8B illustrates a second step for using the system for handling and installing forklift forks of FIG. 3 in accordance with the method of FIG. 8A;

FIG. 8C illustrates a third step for using the system for handling and installing forklift forks of FIG. 3 in accordance with the method of FIG. 8A;

FIG. 8D illustrates a fourth step for using the system for handling and installing forklift forks of FIG. 3 in accordance with the method of FIG. 8A;

FIG. 9A illustrates a first step for using the system for handling and installing forklift forks of FIG. 3 in accordance with a second method of practicing the present invention;

FIG. 9B illustrates a second step for using the system for handling and installing forklift forks of FIG. 3 in accordance with the method of FIG. 9A;

FIG. 9C illustrates a third step for using the system for handling and installing forklift forks of FIG. 3 in accordance with the method of FIG. 9A;

FIG. 10A illustrates a first step for using the system for handling and installing forklift forks of FIG. 6 in accordance with a third method of practicing the present invention;

FIG. 10B illustrates a second step for using the system for handling and installing forklift forks of FIG. 6 in accordance with the method of FIG. 10A; and

FIG. 10C illustrates a third step for using the system for handling and installing forklift forks of FIG. 6 in accordance with the method of FIG. 10A.

### DETAILED DESCRIPTION OF THE INVENTION

Various embodiments of the present invention are described and shown in the accompanying materials, descriptions, instructions, and drawings. For purposes of clarity in illustrating the characteristics of the present invention, proportional relationships of the elements have not necessarily been maintained in the drawings. It will be understood that any dimensions included in the drawings are simply provided as examples, and dimensions other than those provided therein are also within the scope of the invention.

The description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

The present invention is directed generally to a system for handling and installing attachments and particularly, to a system for handling and installing forklift forks. The system for handling and installing forklift forks may be selectively coupled to a forklift or other piece of equipment. In addition, the system for handling and installing forklift forks may engage with one or more spare forklift forks via various means. In various embodiments, such means may include a fork opening, a front plate, and/or a shaft mounting apparatus configured to engage with blade portions, hook portions, clip portions, collars, or eyelets of spare forks, respectively. Advantageously, when the spare forks are coupled to the system for handling and installing forklift forks, the forklift may be controlled to handle or to install the spare forks on a second forklift. Thus, the system for handling and installing forklift forks may reduce or eliminate the need for a human laborer and, therefore, may reduce the costs and safety concerns associated with handling, moving, and installing forklift forks.

The present disclosure is directed to various embodiments, including embodiments 100 and 100b of a system for handling and installing forklift forks. Each of the embodiments 100 and 100b of the system for handling and installing forklift forks can engage with fork attachments in a plurality of different manners. For illustrative purposes, three methods of using the systems for handling and installing forklift forks are described. For illustrative purposes, one embodiment 100 of the system for handling and installing forklift forks is used when describing the first method and the second method. It will be understood that another embodiment 100b of the system for handling and installing forklift forks may also be used when practicing the first method and the second method. Furthermore, the third method is described using the other embodiment 100b of the system for handling and installing forklift forks, but it will be understood that the third method may be practiced using any embodiments that include a shaft mounting apparatus.

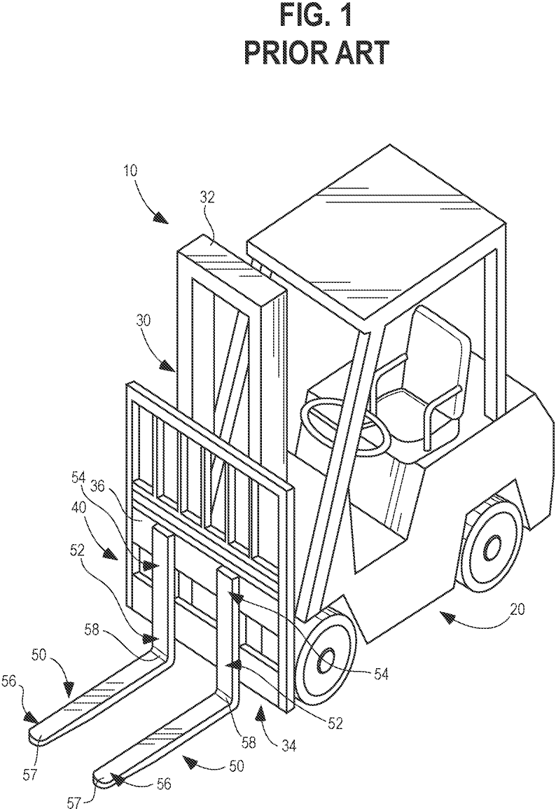

Turning to FIG. 1, a forklift 10, as known in the art, is illustrated. Forklifts 10 generally comprise a motorized vehicle portion 20, a lift portion 30, and a loading system 40. The lift portion 30 commonly includes a lift carriage 34 coupled to the loading system 40. The lift carriage 34 is vertically movable up and down a mast 32 of the forklift 10. The movement of the lift portion 30 is traditionally controlled by an operator of the forklift 10. As illustrated, the loading system 40 may include a pair of forks 50 that are elongated bodies extending outwardly from the front of the forklift 10.

The forks 50 are preferably substantially L-shaped. The forks 50 may each have a substantially vertical portion, or shank 52, and a substantially horizontal portion, or blade 56. The shank 52 and the blade 56 of each fork 50 may be connected by a bend or heel 58. Opposite from the heel 58, each shank 52 may include an upper end 54. At the upper end 54 of each shank 52, there may be a mounting mechanism 60 (not shown). Opposite from the heel 58, the blade 56 of each fork 50 may terminate in a tip 57. In some embodiments, the tip 57 may be a tapered distal end or a rounded distal end.

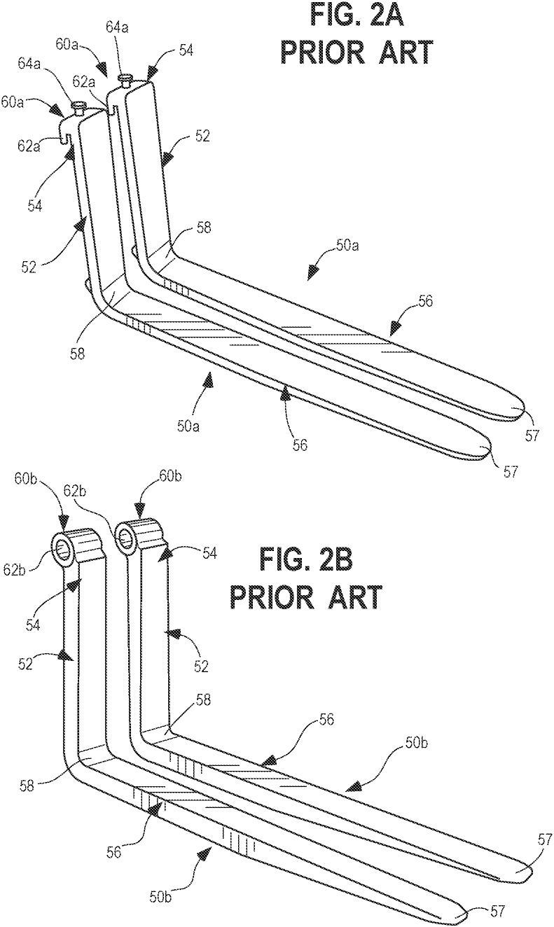

Various methods of coupling the forks 50 to the loading system 40 are known in the art. For example, FIG. 2A illustrates a pair of ITA forks 50a, and FIG. 2B illustrates a pair of shaft-mounted forks 50b, as known in the art. The ITA forks 50a and the shaft-mounted forks 50b may be positioned and located on forklifts 10 similar to the forks 50 described in reference to FIG. 1. Similar to the forks 50 described in reference to FIG. 1, each of the ITA forks 50a and the shaft-mounted forks 50b may include a shank 52, a blade 56, a heel 58, and a tip 57.

As illustrated in FIG. 2A, each of the ITA forks 50a may include a mounting mechanism 60a attached to the upper end 54 of the shank 52. The mounting mechanism 60a of ITA forks 50a generally comprises a hook portion 62a and a locking mechanism 64a. Accordingly, the ITA forks 50a are also referred to as clip-mounted or hook type forks. The hook portion 62a of the ITA forks 50a is generally adapted to receive a crossbar 36 (see FIG. 1) of a carriage 34 of a forklift 10. When the hook portion 62a receives the crossbar 36, the locking mechanism 64a may be utilized to secure the ITA fork 50a to the crossbar 36.

As shown in FIG. 2B, each of the shaft-mounted forks 50b also include a mounting mechanism 60b. The mounting mechanism 60b of shaft-mounted forks 50b generally includes an collar with an aperture 62b attached to the upper end 54 of the shank 52. The aperture 62b of the collar may be a circular aperture adapted for receiving a shaft (not shown) of a carriage 34. The diameter of the collar aperture 62b may be the same as or slightly larger than the diameter of the shaft on the carriage 34. Accordingly, the collar of the shaft-mounted forks 50b may be retained on the shaft using a friction fit. Thus, the collars may be utilized to couple the shaft-mounted forks 50b to the carriage 34 of the forklift 10.

Example forks 50, 50a, and 50b for forklifts 10 have been described for illustrative purposes. It will be appreciated by one of ordinary skill in the art, however, that the teachings of the present disclosure may also be used in connection with a variety of attachments, including but not limited to various fork attachments. Examples of such attachments include telehandler forks, bucket forks, blank forks, fully tapered and polished (FTP) forks, and other types of forks and attachments for industrial and construction equipment, now known and hereafter developed. As such, it will be appreciated by one of ordinary skill in the art, that the systems and methods herein may also be adapted for use in connection with the forks and attachments incorporating the connection system disclosed in U.S. Pat. No. 10,815,105 for a Quick Connect System for Industrial and Construction Equipment.

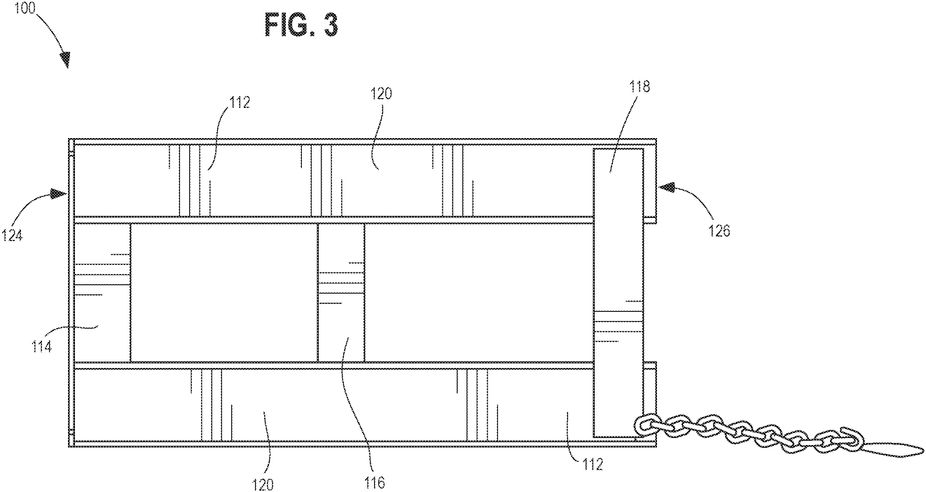

In FIGS. 3-5, a system for handling and installing attachments 100 is illustrated. The system for handling and installing attachments 100 may be used with various attachments such as forks 50 or other tools. Accordingly, the system for handling and installing attachments 100 may also be called a system for handling and installing forklift forks 100. In accordance with one embodiment of the present invention, the system for handling and installing forklift forks 100 may be configured to be received by a forklift 10. When received by the forklift 10, the system for handling and installing forklift forks 100 may be utilized to handle, move, and/or install one or more forklift forks 50, as described in greater detail below. It will be further understood that the system for handling and installing forklift forks 100 may be coupled with or otherwise attached to a variety of industrial and construction equipment, including but not limited to forklifts 10, in a variety of suitable manners.

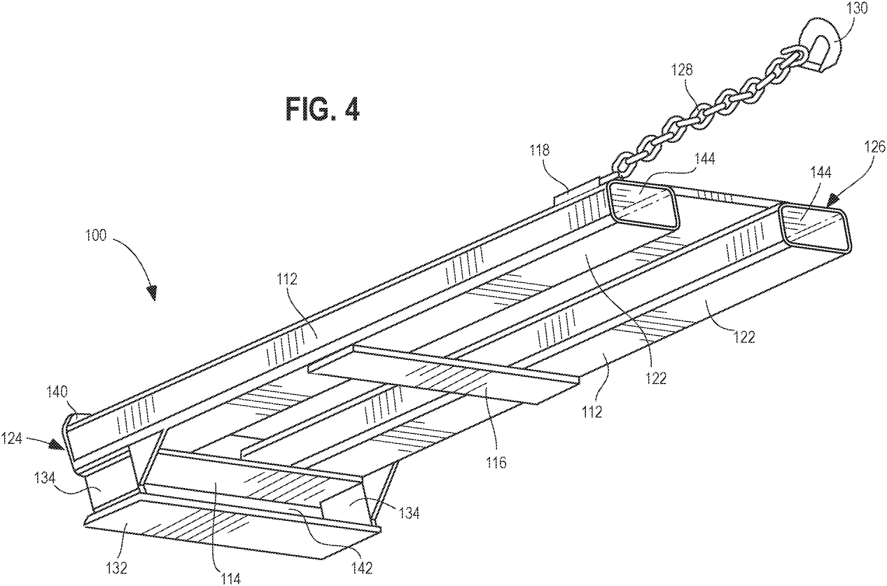

As illustrated in FIG. 3, the system for handling and installing forklift forks 100 may include a pair of fork pocket members 112 that extend from a proximal end 126 to a distal end 124. The fork pocket members 112 may be in the form of rectangular elongated tubes with a top face 120 and a bottom face 122 (see FIG. 4). It will be appreciated that the system for handling and installing forklift forks 100 may include suitable structures other than the fork pocket members 112 in the form of rectangular elongated tubes. In alternative embodiments, the fork pocket members 112 may, for example, have a trapezoidal, elliptical, or channel-shaped cross section.

As further illustrated in FIG. 3, the fork pocket members 112 may be configured generally parallel to one another and may be connected by one or more crossmembers. In the illustrated embodiment, a front crossmember 114, a center crossmember 116, and a rear crossmember 118 connect the fork pocket members 112 together. The rear crossmember 118 may be positioned and located generally at the proximal end 126 of the fork pocket members 112. Furthermore, the rear crossmember 118 may be coupled to the top face 120 of the fork pocket members 112. In some embodiments, the front crossmember 114, the center crossmember 116, and the rear crossmember 118 are substantially equal in length and substantially rectangular in shape. For example, in the illustrated embodiment, the front crossmember 114, the center crossmember 116, and the rear crossmember 118 are rectangular sheet metal plates that are substantially similar. It will be appreciated by one of ordinary skill in the art, however, that in other embodiments, the front crossmember 114, the center crossmember 116, and the rear crossmember 118 may comprise other suitable structures (e.g., round metal tubes, angle irons, flanged beams, and c-channels).

As best shown in FIG. 4, the front crossmember 114 may be attached to the bottom face 122 of the fork pocket members 112. Furthermore, the front crossmember 114 may be positioned and located generally at the distal end 124 of the fork pocket members 112. Similarly, the center crossmember 116 may be attached to the bottom face 122 of the fork pocket members 112. The center crossmember 116 may be positioned and located between the front crossmember 114 and the rear crossmember 118. In the illustrated embodiment, the center crossmember 116 is positioned and located approximately equidistant from the proximal end 126 and the distal end 124 of the fork pocket members 112. In alternative embodiments, however, the center crossmember 116 may be positioned and located closer towards the distal end 124 or closer towards the proximal end 126. In yet another embodiment, the system for handling and installing forklift forks 100 may include more than one center crossmember 116.

As shown in FIG. 4, the system for handling and installing forklift forks 100 may include a bottom wall or lip 132. The lip 132 may be a bottom crossmember positioned and located below the front crossmember 114, below the fork pocket members 112, and/or below a front upwardly extending projection or plate 140 (described below). The lip 132 may extend between, be suspended from, and connected to the remainder of the system for handling and installing forklift forks 100 by opposing vertical members or side walls 134. In another embodiment, the lip 132 need not be suspended from side walls 134 and instead be attached directed to the pocket members 112. As shown, the side walls 134 may be substantially rectangular metal plates.

As further shown in FIG. 4, the fork pocket members 112 may each include an opening 144 at their respective proximal ends 126. The openings 144 are configured to receive forks 50 attached to a forklift 10. Thus, the system for handling and installing forklift forks 100 may be coupled with a forklift 10. Further, a chain 128 and a hook 130 may be coupled to the rear crossmember 118. As will be described in further detail below, the chain 128 and the hook 130 may be utilized to secure and retain the system for handling and installing forklift forks 100 to the forklift 10. In alternative embodiments, the chain 128 and the hook 130 may be attached to other suitable portions of the system for handling and installing forklift forks 100. As will be recognized by those skilled in the art, alternative features may also be included to provide alternative means for attaching the system for handling and installing forklift forks 100 to the forklift 10. For instance, in alternative embodiments, the fork pocket members 112 may include clips or hooks (similar to those found on ITA forks 50a) located at the proximal end 126 and configured to couple the fork pocket members 112 to the forklift 10.

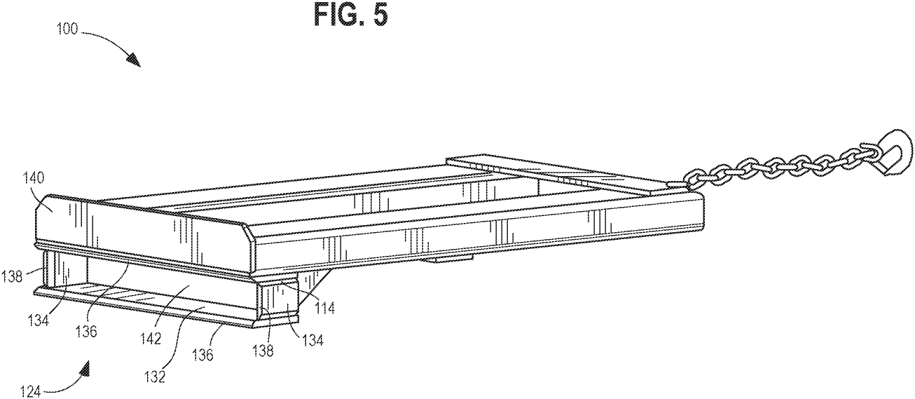

As best shown in FIGS. 4 and 5, the system for handling and installing forklift forks 100 may include a front upwardly extending projection or plate 140 positioned and located at the distal end 124. The front projection or plate 140 may be substantially rectangular and may be configured to provide a means of engaging and lifting forks 50 (as described in greater detail below). As shown in FIGS. 4 and 5, the front crossmember 114 (and/or the front plate 140), the lip 132, and the side walls 134 connect to form and define a fork opening 142. The fork opening 142 may be a slot, a gap, or a space. The fork opening 142 may be configured to receive and handle forklift forks 50, as described in greater detail below. In one embodiment, the fork opening 142 may have a width suitable for receiving one or more forks 50 (e.g., 2, 4, or 6 forks).

As also shown in FIG. 5, the front crossmember 114 and the lip 132 of the system for handling and installing forklift forks 100 may each optionally include beveled front edges 136. The beveled front edges 136 may be located on a upper front edge of the lip 132 and a lower front edge of the front crossmember 114. In addition, the side walls 134 may include beveled side edges 138. Together, the beveled front edges 136 and the beveled side edges 138 may be configured to aid in engaging, sorting, and handling forklift forks 50 (as described in greater detail below). In alternative embodiments, the front crossmember 114, the lip 132, and the side walls 134 may include rounded or chamfered edges configured to aid in engaging, sorting, and handling forklift forks.

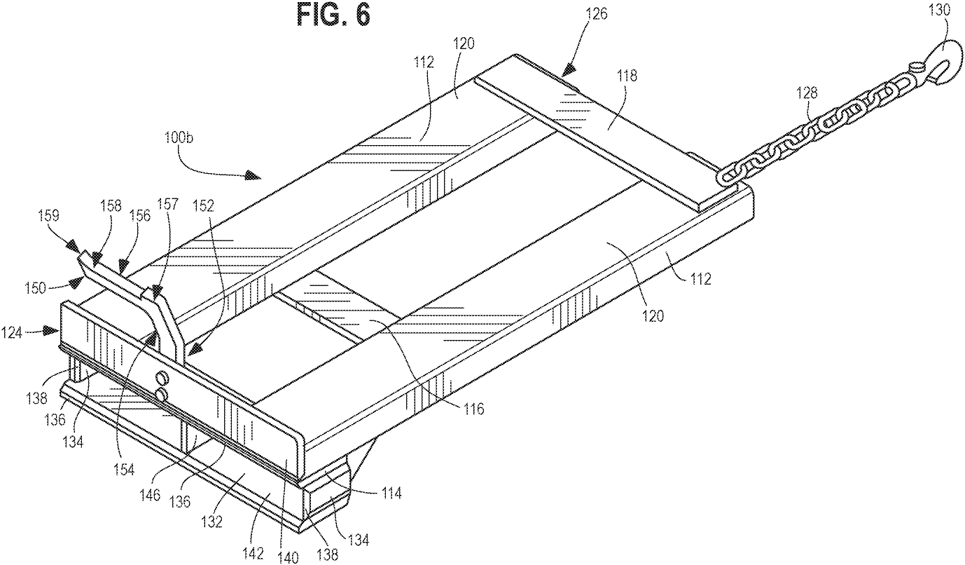

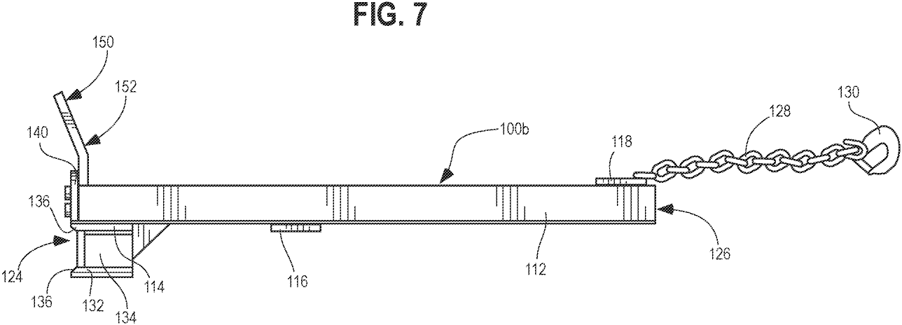

FIGS. 6 and 7 illustrate another system for handling and installing forklift forks 100b. This system for handling and installing forklift forks 100b may be substantially similar to the system for handling and installing forklift forks 100. As illustrated, the system for handling and installing forklift forks 100b includes fork pocket members 112 with top faces 120 (see FIG. 6), bottom faces 122 (not shown), and openings 144 (not shown). Similarly, the fork pocket members 112 extend from a proximal end 126 to a distal end 124. The system for handling and installing forklift forks 100b may also include a front crossmember 114, a center crossmember 116, a rear crossmember 118, a lip 132, side walls 134, a front plate 140, and a fork opening 142 (see FIG. 6) that are substantially similar to those found on the system for handling and installing forklift forks 100. As illustrated, the front crossmember 114 and the lip 132 may include beveled front edges 136. The side walls 134 may also be provided with beveled side edges 138 (see FIG. 6). In addition, a chain 128 and a hook 130 are illustrated at the proximal end 126. In contrast to the system for handling and installing forklift forks 100, the system for handling and installing forklift forks 100b includes additional means for handling forks 50. Specifically, the system for handling and installing forklift forks 100b may include a shaft mounting apparatus 150 for engaging with shaft-mounted forks 50b.

As best shown in FIG. 6, the shaft mounting apparatus 150 may comprise a vertical portion 152 and a horizontal portion 156. The vertical portion 152 and the horizontal portion 156 may be formed integrally together from a metal plate. In alternative embodiments, the vertical portion 152 and/or the horizontal portion 156 may be formed separately from tubes, shafts, or other suitable structures. The vertical portion 152 may have a bottom end 153 (not shown) and a top end 154. At the top end 154, the vertical portion 152 may be coupled to the horizontal portion 156. At the bottom end 153, the vertical portion 152 may be permanently or removably coupled to the system for handling and installing forklift forks 100b. In the illustrated embodiment, the bottom end 153 of the vertical portion 152 is coupled to the front plate 140 using bolts. In alternative embodiments, the vertical portion 152 may be welded to the front plate 140, integrally formed with the front plate 140, or attached to the front plate 140 using any suitable means. In other embodiments, the vertical portion 152 may be attached to other parts of the system for handling and installing forklift forks 100b. For example, the vertical portion 152 may be attached to the fork pocket members 112, the front crossmember 114, or the center crossmember 116. It will be appreciated that the shaft mounting apparatus 150 may be an option feature.

The horizontal portion 156 of the shaft mounting apparatus 150 may comprise three regions. Proximal to the vertical portion 152, there may be a structural region 157. The structural region 157 may be designed for withstanding and transferring loads from the horizontal portion 156 to the vertical portion 152. Adjacent to the structural region 157, there may be a mounting region 158. In the mounting region 158, a cross section of the horizontal portion 156 may be sized and configured such that the collar apertures 62b of shaft-mounted forks 50b (see FIG. 2B) may be receive the mounting region 158. Located opposite from the structural region 157 and located adjacent to the mounting region 158, there may be an end-stop region 159. In the end-stop region 159, the horizontal portion 156 may curve upwardly. Furthermore, in the end-stop region 159, the size of the cross section of the horizontal portion 156 may increase. For example, the cross section of the horizontal portion 156 may be larger and/or different in the end-stop region 159 than the cross section of the horizontal portion 156 in the mounting region 158. Thus, the end-stop region 159 may be configured to decrease the likelihood of the shaft-mounted forks 50b sliding off of the horizontal portion 156.

In contrast to the system for handling and installing forklift forks 100, the system for handling and installing forklift forks 100b may include a center plate 146. The center plate 146 may be located in the fork opening 142 and may extend from the lip 132 to the front crossmember 114. The center plate 146 may be oriented substantially parallel to the side walls 134. The center plate 146 may provide additional structural strength to the system for handling and installing forklift forks 100b. Specifically, the center plate 146 may carry a portion of the load received by and transmitted by the shaft mounting apparatus 150. In addition, the center plate 146 may act to divide the fork opening 142. When forks 50 are received in the fork opening 142, some of the forks 50 may be located on one side of the center plate 146, and other forks 50 may be located on the other side of the center plate 146. Dividing the fork opening 142 may prevent the forks 50 from sliding and colliding into each other. Dividing the fork opening 142 may also limit the horizontal sliding of the forks 50 such that the center of gravity for the system for handling and installing forklift forks 100b is relatively static.

As best illustrated in FIG. 7, the vertical portion 152 of the shaft mounting apparatus 150 may be angled outwardly from, or otherwise positioned in a forward orientation relative to, the distal end 124 of the system for handling and installing forklift forks 100b. Accordingly, the horizontal portion 156 (see FIG. 6) may extend along a plane located entirely in front of the front plate 140. Thus, when shaft-mounted forks 50b are located in front of the system for handling and installing forklift forks 100b, the operator may position the horizontal portion 156 within the collar apertures 62b. Further, the angle of the vertical portion 152 may be configured to assist the operator with concentrically aligning the horizontal portion 156 with the collar apertures 62b. For example, the vertical portion 152 may be configured such that the horizontal portion 156 is located a predetermined distance in front of the front plate 140. The predetermined distance may be selected such that when the shanks 52 of the shaft-mounted forks 50b abut the front plate 140 (or are flush with the front plate 140), the collar apertures 62b are aligned with the horizontal portion 156. Accordingly, the operator may align the horizontal portion 156 with the collar apertures 62b by positioning the forklift 10 such that the front plate 140 abuts the shaft-mounted forks 50b. In alternative embodiments, the angle of the vertical portion 152 may be configured such that the front crossmember 114, the lip 132, and/or the side walls 134 are located a predetermined distance behind the horizontal portion 156.

The systems for handling and installing forklift forks 100, 100b may be used to move, lift, organize, stack and/or store forklift fork(s) 50, 50a, 50b within warehouses, job sites, and other industrial settings. The systems for handling and installing forklift forks 100, 100b may receive and engage one or a plurality of forklift forks 50, 50a, 50b at the same time. Further, the systems for handling and installing forklift forks 100, 100b may be used to install forklift fork(s) 50, 50a, 50b or other attachments onto forklifts 10 or other vehicles, such as construction equipment.

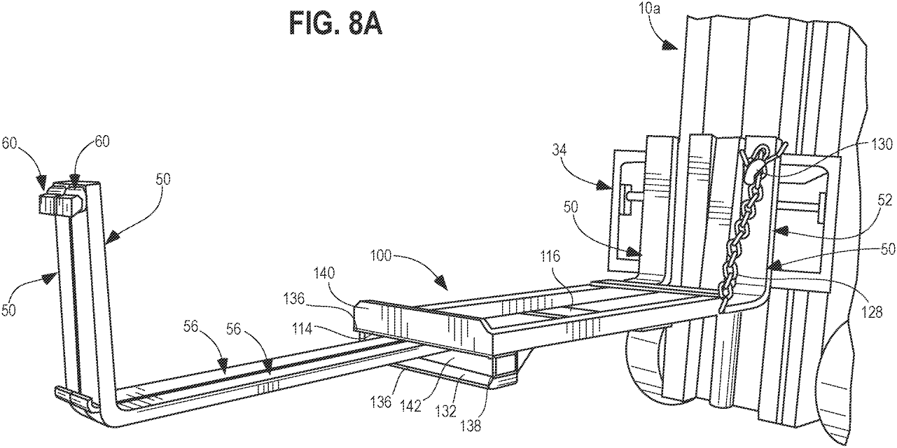

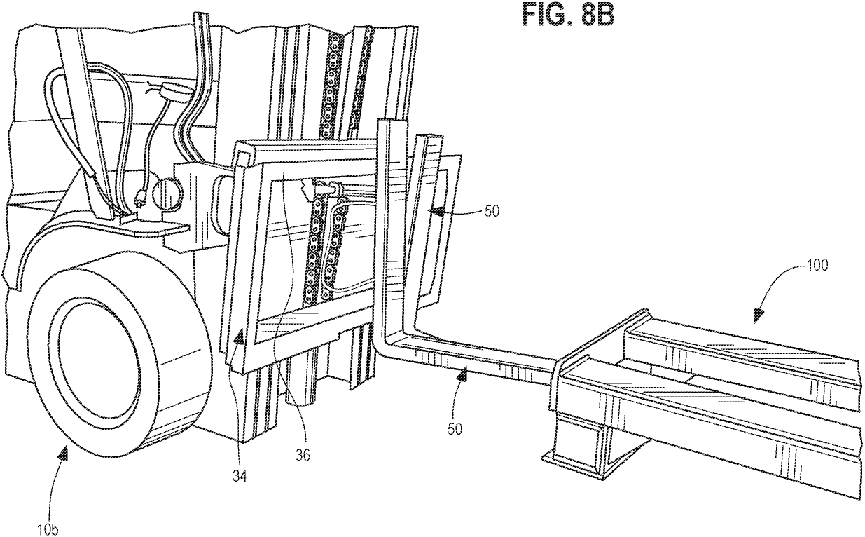

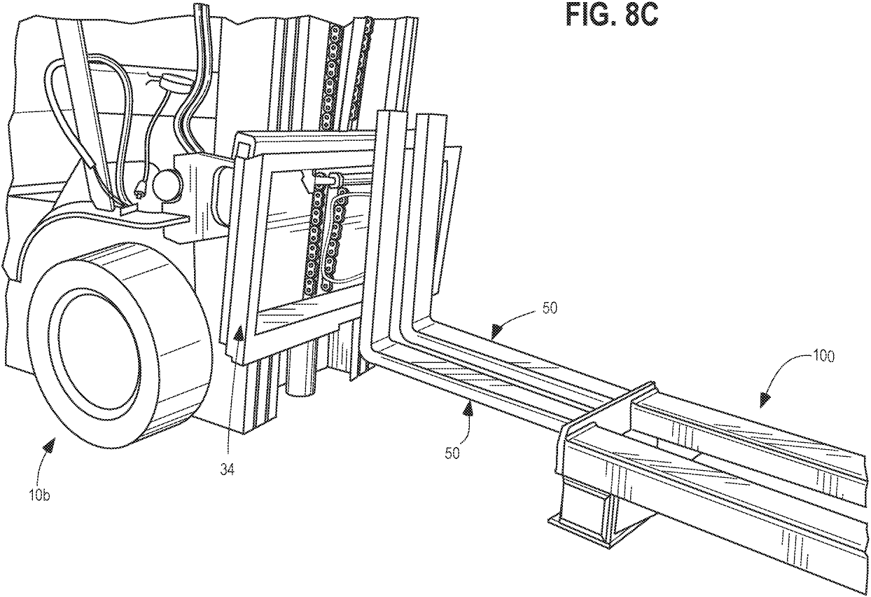

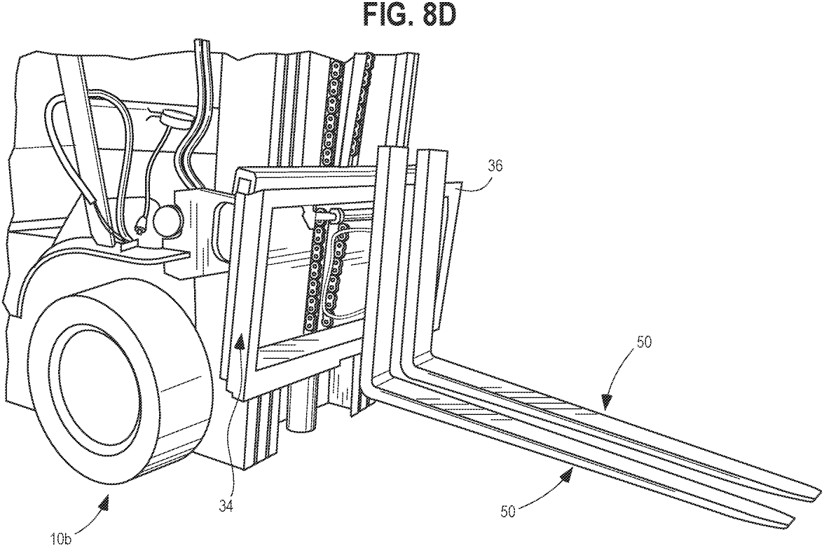

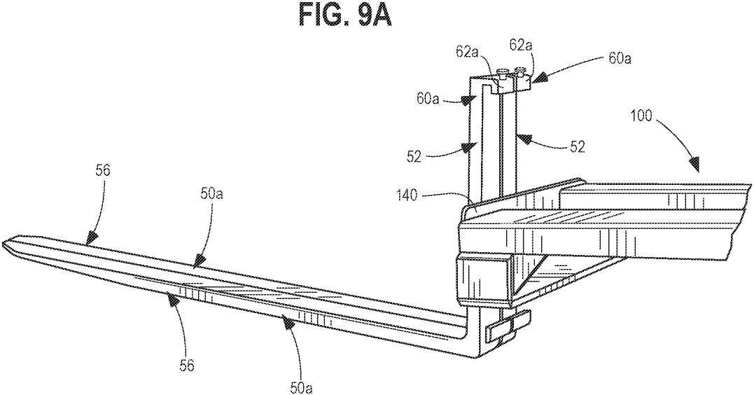

FIGS. 8A-8D illustrate a first method for handling and installing forklift forks 50. When practicing the first method, a first forklift 10a (see FIG. 8A) may handle and transport forks 50. Further, the first forklift 10a may install forks 50 on a second forklift 10b (see FIGS. 8B-8D). The first forklift 10a and the second forklift 10b may be substantially similar to the forklift 10 previously described. In the figures illustrating the first method, the system for handling and installing forklift forks 100 is shown. It will be appreciated by one of ordinary skill in the art, however, that the first method may also be practiced using the system for handling and installing forklift forks 100b or other alternative embodiments. The forks 50 shown to illustrate the first method are ITA forks 50a. However, the first method may also be practiced using shaft-mounted forks 50b or other foreseeable attachments.

When practicing the first method, as shown in FIG. 8A, forks 50 may be attached to the carriage 34 of the first forklift 10a using any suitable mounting mechanism 60 (not shown). The forks 50 may be ITA forks 50a, shaft-mounted forks 50b, or any other type of forks 50. Then, the system for handling and installing forklift forks 100 may be coupled to the forks 50. More particularly, the blades 56 (not shown) and the tips 57 (not shown) of the forks 50 may be received within the openings 144 (not shown). To further couple the system for handling and installing forklift forks 100 to the carriage 34, the chain 128 may be wrapped around the shank 52 of one of the forks 50. Then, the hook 130 may be used to secure the chain 128 around the shank 52. Accordingly, when the carriage 34 of the first forklift 10a is raised, lowered, or moved, the system for handling and installing forklift forks 100 may also be raised, lowered, or moved.

Once the system for handling and installing forklift forks 100 is coupled to the first forklift 10a, an additional set of forks 50 may be provided. The blades 56 of the forks 50 may be received within the fork opening 142 of the system for handling and installing forklift forks 100. To position the blades 56 within the fork opening 142, the operator of the first forklift 10a may begin by aligning the blades 56 with the fork opening 142. To align the blades 56, the operator may control the lift carriage 34 up and down, and the operator may control the motorized vehicle portion 20 (not shown) side-to-side. Once the operator has aligned the fork opening 142 with the blades 56, the operator may control the motorized vehicle portion 20 to move forward.

As the first forklift 10a moves forward, the beveled front edges 136 and the beveled side edges 138 may assist in engaging, receiving, and sorting the forks 50 within the fork opening 142. For instance, if several forks 50 are vertically stacked one on top of another, the beveled front edges 136 and the beveled side edges 138 may be used to receive and engage the forks 50 positioned on the top of the stack (while leaving the remainder of the stack in place). In another instance, if several vertical stacks of forks 50 are placed adjacent to one another, the beveled front edges 136 and the beveled side edges 138 may be used to receive and engage the forks 50 positioned on the top of the multiple stacks (while leaving the remainder of the stacks in place). In yet another instance, if several forks 50 are positioned side-by-side or otherwise adjacent to one another, the beveled front edges 136 and the beveled side edges 138 may be used to receive and engage one or more of the forks 50 (while leaving the remainder of the forks 50 in place).

Once the forks 50 are positioned within the fork opening 142, the lip 132 may support the weight of the forks 50. Additionally, the front crossmember 114, the center crossmember 116, and/or the front plate 140 may abut the blades 56 and impart a downward force on the blades 56. The downward force may prevent the forks 50 from rotating backward. Accordingly, when the forks 50 are positioned within the fork opening 142, the forks 50 may be balanced in a substantially horizontal orientation. Additionally, the contact between the forks 50 and the system for handling and installing forklift forks 100 may frictionally couple the forks 50 to the system for handling and installing forklift forks 100. Thus, the forks 50 may be retained within the fork opening 142. When the system for handling and installing forklift forks 100 moves, the forks 50 may also move. Therefore, when the forks 50 are positioned within the fork opening 142, the forks 50 may be handled by the first forklift 10a via the system for handling and installing forklift forks 100. For example, if the lift carriage 34 of the first forklift 10a is moved up or down, the forks 50 may also move up or down. If the first forklift 10a moves forwards, backwards, or sideways, the forks 50 may also move forwards, backwards, or sideways.

As shown in FIG. 8B, the first forklift 10a may transport the forks 50 to the second forklift 10b. Then, the operator may control the lift carriage 34 (see FIG. 8A) and the motorized vehicle portion 20 (not shown) of the first forklift 10a to align the mounting mechanisms 60 (see FIG. 8A) on the forks 50 with the carriage 34 on the second forklift 10b. For example, the operator may align the hook portions 62a (not shown) of the mounting mechanisms 60 (not shown) with a crossbar 36 on the carriage 34. In alternative embodiments of the first method, the operator may align the collar apertures 62b (not shown) of the mounting mechanisms 60 with a shaft (not shown) on the carriage 34.

Turning to FIG. 8C, once the mounting mechanisms 60 are aligned, the operator may lower the lift carriage 34 of the first forklift 10a (see FIG. 8A). As the lift carriage 34 of the first forklift 10a is lowered, the weight of the forks 50 is transferred from the lip 132 (see FIG. 8A) of the system for handling and installing forklift forks 100 to the lift carriage 34 of the second forklift 10b. Once the lift carriage 34 of the first forklift 10a has been lowered a predetermined amount, the weight of the forks 50 will be entirely carried by the lift carriage 34 of the second forklift 10b. At this moment, the forks 50 will be entirely suspended within the fork opening 142 (see FIG. 8A) of the system for handling and installing forklift forks 100.

Turning to FIG. 8D, once the forks 50 are suspended in the fork opening 142, the frictional connection between the forks 50 and the system for handling and installing forklift forks 100 will be broken. Therefore, the operator of the first forklift 10a (see FIG. 8A) may control the first forklift 10a to move backwards. As the first forklift 10a moves backwards, the forks 50 will remain coupled to the second forklift 10b. Accordingly, the system for handling and installing forklift forks 100 will no longer influence the forks 50, and the forks 50 will not be disturbed as the first forklift 10a moves backwards. Once the first forklift 10a has moved backwards a sufficient distance, the forks 50 will no longer be positioned in the fork opening 142. At this point, if the spacing of the forks 50 relative to one another is too large or too small, the operator may adjust the spacing of the forks 50. Specifically, the operator may control the first forklift 10a to push one or more of the forks 50 using the system for handling and installing forklift forks 100. As the forks 50 are pushed by the system for handling and installing forklift forks 100, the forks 50 may slide or shift horizontally along the crossbar 36 of the lift carriage 34. Once the forks 50 are successfully pushed into position on the second forklift 10b, the first method of handling and installing forklift forks is complete.

If the operator wishes to uninstall the forks 50 from the second forklift 10b, the previously described process may be repeated in reverse. For example, to uninstall the forks 50 from the second forklift 10b, the operator may begin by aligning the forks 50 on the second forklift 10b with the fork opening 142 (see FIG. 8A) on the system for handling and installing forklift forks 100. Once the forks 50 are aligned, the operator may control the first forklift 10a to move forwards. The operator will continue to control the movement of the first forklift 10a until the blades 56 are positioned within the fork opening 142. Then, the operator may control the lift carriage 34 of the first forklift 10a to move upwards. As the lift carriage 34 moves upwards, the weight of the forks 50 will be transferred from the lift carriage 34 of the second forklift 10b to the system for handling and installing forklift forks 100. Once the weight of the forks 50 is transferred, a frictional connection may be formed between the forks 50 and the system for handling and installing forklift forks 100. Therefore, the operator may move the first forklift 10a away from the second forklift 10b, and the forks 50 will move with the first forklift 10a. Thus, the forks 50 will be successfully uninstalled from the second forklift 10b.

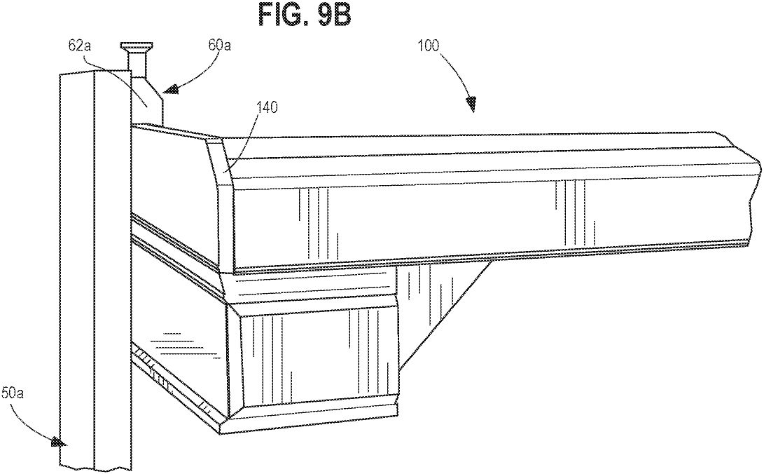

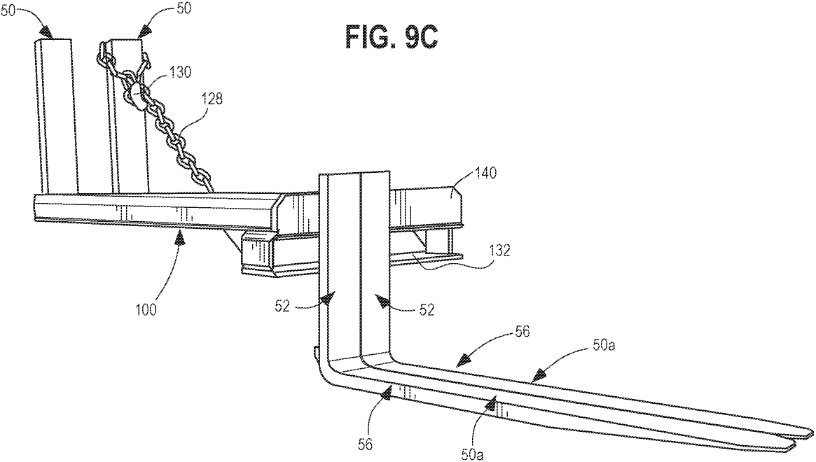

Turning to FIGS. 9A-9C, a second method for handling and installing forklift forks is illustrated. Using the second method, a forklift 10 (not shown) may be used to handle and transport spare ITA forks 50a. Similar to the first method, the second method is illustrated using the system for handling and installing forklift forks 100. It will be appreciated by one of ordinary skill in the art, however, that the second method may also be practiced using the system for handling and installing forklift forks 100b or other alternative embodiments.

Turning to FIG. 9A, a first step of the second method is illustrated. Similar to the first method, a forklift 10 (not shown) is provided with forks 50 (see FIG. 9C) attached to the lift carriage 34 (not shown). The forks 50 may be ITA forks 50a, shaft-mounted forks 50b, or any other type of forks 50. The forks 50 may be coupled to the lift carriage 34 using any suitable mounting mechanism 60 (not shown). Similar to the first method, the forks 50 may be coupled to the system for handling and installing forklift forks 100 using the openings 144 (not shown), the hook 130 (see FIG. 9C), and the chain 128 (see FIG. 9C).

Once the system for handling and installing forklift forks 100 is coupled to the forklift 10, ITA forks 50a may be provided. The ITA forks 50a may be provided on a stable surface. For example, the ITA forks 50a may be provided with the blades 56 resting on the ground. The operator may align the system for handling and installing forklift forks 100 with the ITA forks 50a. Specifically, the operator may position the front plate 140 of the system for handling and installing forklift forks 100 under the mounting mechanisms 60a of the ITA forks 50a. A thickness of the front plate 140 may be configured such that when the front plate 140 abuts the shanks 52 of the ITA forks 50a, the front plate 140 is aligned with the hook portions 62a. In alternative embodiments, the front plate 140 may be aligned with the hook portions 62a when the lip 132 (see FIG. 4) or the front crossmember 114 (see FIG. 4) abut the shanks 52. Once the system for handling and installing forklift forks 100 is aligned, the operator may control the lift carriage 34 of the forklift 10 to move upwards.

Turning to FIG. 9B, as the lift carriage 34 (not shown) is raised, the system for handling and installing forklift forks 100 is also raised. As the system for handling and installing forklift forks 100 is raised, the front plate 140 engages with the mounting mechanisms 60a of the ITA forks 50a (only one shown). Specifically, the front plate 140 may be received within the hook portions 62a of the mounting mechanisms 60a. Accordingly, the ITA forks 50a may be coupled to the front plate 140 of the system for handling and installing forklift forks 100.

Turning to FIG. 9C, the operator may continue to raise the lift carriage 34 (not shown) of the forklift 10 (not shown). As the lift carriage 34 and the system for handling and installing forklift forks 100 are raised, the ITA forks 50a are lifted off the ground by the front plate 140. Once the blades 56 of the ITA forks 50a are lifted off of the ground, the front plate 140 and the lip 132 may abut the shanks 52 of the ITA forks 50a. Together, the front plate 140 and the lip 132 may prevent the ITA forks 50a from rotating forward. Thus, the front plate 140 and the lip 132 may assist with orienting the ITA forks 50a horizontally. The operator may then move the forks 50 to a preferred location by controlling the motorized vehicle portion 20 (not shown) of the forklift 10. Once the forks 50 have been moved to a preferred location, the second method of handling and installing forklift forks 50 is complete.

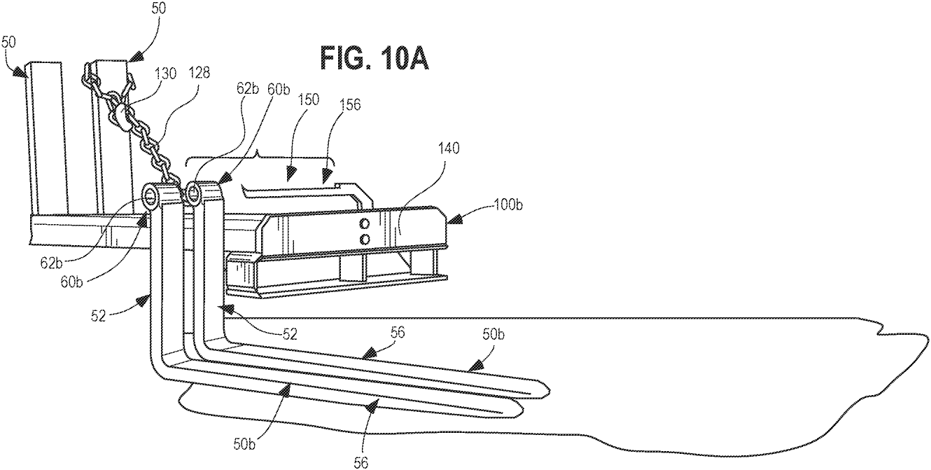

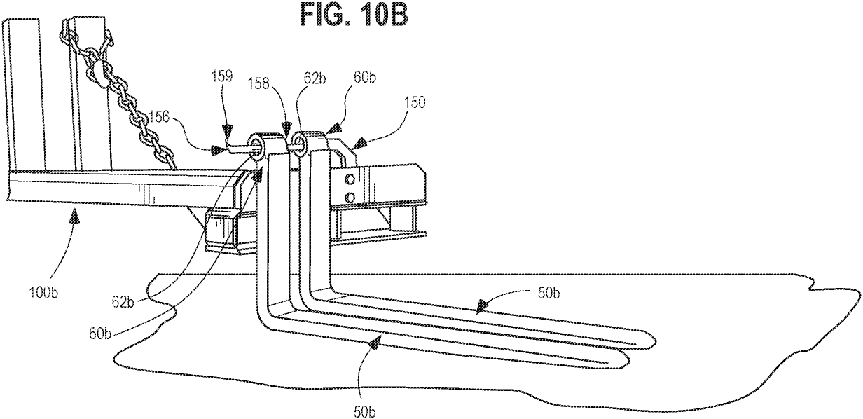

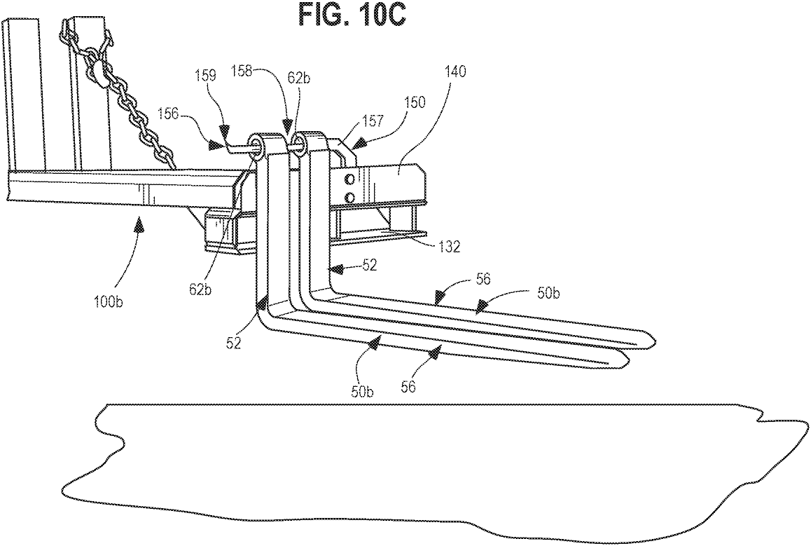

Turning to FIGS. 10A-10C, a third method for handling and installing forklift forks 50 is illustrated. Using the third method, a forklift 10 (not shown) may be used to handle and transport shaft-mounted forks 50b. Unlike the first method and the second method, the third method is illustrated using the system for handling and installing forklift forks 100b. It will be appreciated by one of ordinary skill in the art, however, that the third method may be practiced using any embodiment that comprises a shaft mounting apparatus 150.

Turning to FIG. 10A, a first step of the third method is illustrated. Similar to the first method and the second method, the forklift 10 (not shown) is provided with forks 50 attached to the lift carriage 34 (not shown). The forks 50 may be ITA forks 50a, shaft-mounted forks 50b, or any other type of forks 50. Similar to the first method and the second method, the forks 50 may be coupled to the system for handling and installing forklift forks 100b using the openings 144 (not shown), the hook 130, and the chain 128.

Once the system for handling and installing forklift forks 100b is coupled to the forklift 10, shaft-mounted forks 50b may be provided. The shaft-mounted forks 50b may be provided on a stable surface. For example, the shaft-mounted forks 50b may be provided with the blades 56 resting on the ground. The operator may align the shaft mounting apparatus 150 of the system for handling and installing forklift forks 100b with the mounting mechanisms 60b of the shaft-mounted forks 50b. More specifically, the operator may concentrically align the horizontal portion 156 with the collar apertures 62b. As previously discussed, the shaft mounting apparatus 150 may be configured such that when the front plate 140 is flush with the shanks 52, the horizontal portion 156 is concentrically aligned with the collar apertures 62b. As a result, the operator may align the shaft mounting apparatus 150 with the mounting mechanisms 60b by maneuvering the forklift 10 so that the front plate 140 is flush with the shanks 52. Once the system for handling and installing forklift forks 100b is aligned, the operator may control the forklift 10 to move sideways.

Turning to FIG. 10B, as the forklift 10 (not shown) moves sideways, the system for handling and installing forklift forks 100b also moves sideways. As the system for handling and installing forklift forks 100b moves to the side, the shaft mounting apparatus 150 engages with the mounting mechanisms 60b of the shaft-mounted forks 50b. Specifically, as the forklift 10 moves to the side, the end-stop region 159 of the shaft mounting apparatus 150 may be received within the collar apertures 62b of the mounting mechanisms 60b. Then, as the forklift 10 continues to move to the side, the shaft mounting apparatus 150 may move such that the collars are positioned on the mounting region 158 of the horizontal portion 156.

Turning to FIG. 10C, once the collars are positioned on the mounting region 158, the operator may raise the lift carriage 34 (not shown) of the forklift 10 (not shown). As the lift carriage 34 and the system for handling and installing forklift forks 100b are raised, the shaft-mounted forks 50b are lifted off the ground by the shaft mounting apparatus 150. Once the blades 56 of the shaft-mounted forks 50b are off of the ground, the front plate 140 and the lip 132 may abut the shanks 52 of the shaft-mounted forks 50b. Together, the front plate 140 and the lip 132 may prevent the shaft-mounted forks 50b from rotating forward, and thus, may assist with orienting the shaft-mounted forks 50b horizontally. Additionally, once the shaft-mounted forks 50b are off of the ground, the end-stop region 159 and the structural region 157 may prevent the shaft-mounted forks 50b from sliding off of the mounting region 158 of the horizontal portion 156 of the shaft mounting apparatus 150. At this point, the operator may maneuver the forklift 10 to transport and handle the shaft-mounted forks 50b.

From the foregoing, it will be seen that this invention is one well adapted to attain all the ends and objects hereinabove set forth together with other advantages which are obvious, and which are inherent to the structure. It will be understood that certain features and sub combinations are of utility and may be employed without reference to other features and sub combinations. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including”, and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention.

What is claimed is:

1. A system for handling and installing forklift forks, the system comprising:
a first longitudinally extending fork pocket member;
a second longitudinally extending fork pocket member;
a first crossmember extending between and coupled to the first fork pocket member and the second fork pocket member;
a second crossmember positioned below and vertically spaced apart from the first crossmember; and
a fork opening defined at least partially between the first crossmember and the second crossmember, wherein the fork opening is configured to receive a blade portion of one or more forklift forks.

2. The system of claim 1 further comprising:
a first side vertical member coupled to and depending downwardly from the first fork pocket member; and
a second side vertical member coupled to and depending downwardly from the second fork pocket member;
wherein the second crossmember extends between and is coupled to lower ends of both the first side vertical member and the second side vertical member.

3. The system of claim 2, wherein the fork opening is defined by the first crossmember, the second crossmember, the first side vertical member, and the second side vertical member.

4. The system of claim 1, wherein the second crossmember includes at least one beveled edge configured to assist in engaging and receiving the forklift forks within the fork opening.

5. The system of claim 1, wherein the first and second fork pocket members are elongated tubes that are generally parallel with one another.

6. The system of claim 1 further comprising:
a third crossmember extending between and coupled to the first fork pocket member and the second fork pocket member;
wherein, when the one or more forklift forks is received in and extends through the fork opening, a bottom side of the blade portion of the one or more forklift forks rests on the second crossmember and a top side of the blade portion contacts the third crossmember.

7. The system of claim 1, wherein:
the first and second fork pocket members each define a pocket opening proximate a second end of the system, the pocket openings being configured to receive forks attached to a forklift;
the fork opening is proximate a first end of the system.

8. The system of claim 1 further comprising a front upwardly extending projection proximate a first end of the system and extending between the first fork pocket member and the second fork pocket member, wherein the front upwardly extending projection is configured for being received within a hook portion of the forklift forks.

9. The system of claim 1 further comprising a shaft mounting apparatus proximate a first end of the system, the shaft mounting apparatus including a horizontally extending portion configured for being received within collars of shaft-mounted forklift forks.

10. A system for handling and installing forklift forks, the system comprising:
a first end and a second end;
a first longitudinally extending fork pocket member;
a second longitudinally extending fork pocket member; and
a front upwardly extending projection proximate the first end of the system and extending between the first fork pocket member and the second fork pocket member;
wherein the front upwardly extending projection is configured for being received within a hook portion of the forklift forks.

11. The system of claim 10, wherein the front upwardly extending projection is a plate.

12. The system of claim 10, wherein the front upwardly extending projection has a thickness configured for being received within the hook portion of the forklift forks.

13. The system of claim 10 further comprising:
a first crossmember extending between and coupled to the first fork pocket member and the second fork pocket member;
a second crossmember positioned below and vertically spaced apart from the first crossmember; and
a fork opening defined at least partially between the first crossmember and the second crossmember, wherein the fork opening is configured to receive a blade portion of one or more forklift forks.

14. The system of claim 10 further comprising a shaft mounting apparatus proximate the first end of the system, the shaft mounting apparatus including a horizontally extending portion configured for being received within collars of shaft-mounted forklift forks.

15. A system for handling and installing forklift forks, the system comprising:
a first end and a second end;
a first longitudinally extending fork pocket member;
a second longitudinally extending fork pocket member; and
a shaft mounting apparatus proximate the first end of the system, the shaft mounting apparatus including a horizontally extending portion configured for being received within collars of shaft-mounted forklift forks;
wherein the first and second fork pocket members each define an opening proximate a second end of the system, the openings being configured to receive forks attached to a forklift.

16. The system of claim 15, wherein the shaft mounting apparatus further includes a generally vertically extending portion, wherein the horizontally extending portion is coupled to the vertically extending portion.

17. The system of claim 16, wherein the vertically extending portion is angled forwardly such that the horizontally extending portion is a forwardmost element of the system.
